(19) United States
(12) Patent Application Publication
(10) Pub. No.: US 2021/0025517 A1
(43) Pub. Date: Jan. 28, 2021

(54) ELECTROMAGNETIC VALVE AND DIVERT-AIR VALVE

(71) Applicant: WOCO Industrietechnik GmbH, Bad Soden-Salmünster (DE)

(72) Inventors: Klemens Schander, Bad Soden-Salmünster (DE); Bjoern Diessl, Bad Soden-Salmünster (DE); Stefan Dinges, Bad Soden-Salmünster (DE)

(73) Assignee: WOCO Industrietechnik GmbH, Bad Soden-Salmünster (DE)

(21) Appl. No.: 17/067,202

(22) Filed: Oct. 9, 2020

Related U.S. Application Data
(63) Continuation of application No. PCT/EP2019/059264, filed on Apr. 11, 2019.

(30) Foreign Application Priority Data
Apr. 11, 2018 (DE) 202018101968.6

(51) Int. Cl. F16K 37/00; F16K 31/42; F16K 31/06; H01F 7/08; H01F 7/16; H01F 27/28; H01F 7/02

(52) U.S. Cl. CPC F16K 37/0041; F16K 31/42; F16K 31/0679; F16K 31/423; H01F 7/1607; H01F 27/28; H01F 7/02; H01F 7/081

(57) ABSTRACT

An electromagnetic valve, such as a pilot valve for controlling a main valve or a pilot-operated valve in a divert-air valve, may include at least one valve member in operative connection with a plunger movable along a first axis and at least one coil element. A movement of the plunger or of the valve member is caused by an energization of the coil element, and at least one sensing element by which at least one parameter of the coil element is detectable. The position of the plunger and/or of the valve member can be determined by the parameter. The valve may be part of a divert-air valve system

### PRIORITY

This application is a continuation application of International PCT Patent Application No. PCT/EP2019/059264 filed on Apr. 11, 2019, entitled “ELECTROMAGNETIC VALVE AND AIR DIVERTER VALVE,” which claims priority to German Patent Application No. 20 2018 101 968.6 filed on Apr. 11, 2018, the entire contents of each of which are herein incorporated by reference.

### TECHNICAL FIELD

The present embodiments relate to a valve (e.g. electromagnetic valve, such as a pilot valve) for controlling a main valve, such as a pilot-operated valve in a divert-air valve. The valve includes at least one valve member in operative connection with at least one plunger movable along a first axis and at least one coil element, wherein a movement of the plunger or of the valve member is caused by energization of the coil element. The valve may be part of a divert-air valve system.

### BACKGROUND

An example divert-air valve is disclosed in the applicant's DE 20 2016 104 363 U1. The divert-air valve comprises a main valve by which the flow of at least one fluid, in particular within a motor vehicle, can be controlled along a fluid path. The main valve works pneumatically, wherein the actuation of the main valve is performed via an electromagnetic control valve or pilot valve. This divert-air valve has a lower energy requirement in comparison to divert-air valves in which a direct electromagnetic actuation of the main valve is performed. The pressures present in the fluid path are used to support the movement of the pilot or control valve, thereby reducing its energy consumption. However, it may require an additional sensor unit to determine the operative position of the divert-air valve, particularly of the pilot valve. The additional sensor element may be arranged on the valve member of the main valve or pilot valve. This requires a certain mounting space to be provided for the sensor element such that the overall assembly volume is increased for a sufficient structural rigidity and thus operational safety of the valve member.

### SUMMARY

It is therefore an objective of the present embodiments to provide an electromagnetic valve which is in particular usable as a control valve and/or pilot valve in a divert-air valve, that can enable a monitoring of a switch position of the divert-air valve or the pilot valve in a simple constructive and reliable manner. Moreover, it would be desirable to further decrease the energy consumption of the divert-air valve or pilot valve. This objective is solved with the electromagnetic valve that includes a sensing element with which at least one parameter of the coil element is detectable, wherein the position of the plunger or of the valve member can be determined by the parameter. The coil element at least sectionally, preferably at least sectionally coaxially, surrounds the first axis and/or the plunger.

The coil element may comprise at least two single coils, preferably exactly two single coils, wherein the single coils are arranged behind one another along the first axis and/or at least one single coil, particularly all single coils, preferably at least sectionally or sectionally coaxially surrounds the first axis or the plunger. At least one permanent magnet is arranged between the two single coils in regard to the first axis, wherein the permanent magnet is at least sectionally formed as a ring magnet, in particular at least sectionally or sectionally coaxially surrounding the first axis or the plunger.

Furthermore in some embodiments the sensing element detects at least one first parameter of a first single coil and/or at least one second parameter of a second single coil, wherein the permanent magnet is arranged between the first single coil and the second single coil.

An electromagnetic valve according to some embodiments may include at least one open loop and/or closed loop control device, wherein the open loop and/or closed loop control device is operatively coupled with the sensing device, the coil element and/or the single coil, in particular the first single coil and/or the second single coil, and/or by the plunger and/or the valve member being movable into at least two different positions along the first axis by the open loop and/or closed loop control device.

In the above-mentioned embodiments, the movement of the plunger and/or of the valve member is performed by actuating the coil element, in particular the single coil, or a plurality of the single coils, dependent upon a target value, such as a target-value provided to a target-value input of the open loop and/or closed loop control device. In some embodiments, the open loop and/or closed loop control device can cause a comparison to be performed between the target value and an actual position of the plunger and/or of the valve member detected by the sensing device.

In some embodiments, a first position of the plunger and/or of the valve member corresponds to a closed position, in which the valve member lies sealingly on at least one valve seat, particularly for closing a connection between at least one valve entry and at least one valve exit. A second position of the plunger and/or of the valve member corresponds to an open position, in which the valve member is at least sectionally lifted from the valve seat for opening a connection between the valve entry and the valve exit.

The parameter, in particular the first parameter and/or the second parameter, comprises at least an inductivity, at least an ohmic resistance, and/or at least an impedance of the coil element and/or of the single coil.

Furthermore, some embodiments include a divert-air valve comprising at least one main valve. The main valve may be pneumatic or hydraulic. The divert-air valve includes the main valve and at least one pilot valve for controlling the main valve, wherein the pilot valve is formed as an electromagnetic valve in accordance with the other embodiments discussed herein.

The main valve may be realized as two-way-valve or as a three-way-valve. The main valve may be put into operating positions. For a two-way-valve, in one operative position, the fluid entry is sealed off from the fluid exit, whereas in the second operative position the fluid entry is connected to the fluid exit. For a three-way-valve all three conduits, particularly the fluid entry and the two fluid exits, are provided. In one operating position, the fluid entry is connected with only one of the two fluid exits, while the other fluid exit is sealed off from the fluid entry. In a second operative position, the other fluid exit is connected to the fluid entry while the first fluid exit is sealed off from the fluid entry. To this end, the valve member of the main valve comprises a respective sealing element each, which cooperates with one respective valve seat of the main valve in the corresponding operative position, in particular sealingly closes one respective fluid exit in relation to the fluid entry. For the embodiment of the main valve as a three-way-valve, the fluid exits are arranged in a parallel with the fluid entry, in particular in the shape of a tuning fork relative to one another.

The valve member of the main valve is configured as a hollow body having an entry opening facing towards a fluid entry and having an exit opening facing towards the pilot valve, via which the pilot valve may be subjected through the valve member with the fluid-entry-side pressure.

The embodiments are based on the design configuration of an electromagnetic valve, which simultaneously allows for the detection of a position of a valve member of the valve that may be significantly simplified by employing a sensing unit which does not make any additional attachment or fixture to the valve member or the movable parts necessary, and by performing an analysis of the parameters of the coil element of the valve. In particular it is advantageous to detect the inductivity of the coil element, for example by detecting the voltage of the provided current and/or the phase shift and to deduct the position of the plunger or valve member of the electromagnetic valve by a sensing unit. The involved necessary assembly space is significantly reduced in comparison to the sensor units known from the prior art, because no additional attachments such as sensor elements on movable parts are necessary, but merely the electronics which are provided for a sensor unit.

A particularly simple monitoring of the operative position of the pilot valve or main valve results in the pilot valve as a bistabile valve. Such a bistabile embodiment of the valve furthermore provides the advantage that the energy efficiency may be further improved by significantly reducing the energy consumption. For the bistabile embodiment of the valve it is provided that the coil element comprises at least two single coils between which a permanent magnet element, in particular a ring-permanent-magnet element is provided. In this way it is possible to achieve an energy saving control of the flow of the medium. Simultaneously, the operative switching of high pressures can be achieved with such a bistabile embodiment, in particular due to using the pressures of the controlled fluid, wherein a lower cumulated weight can be achieved. Due to the bistabile embodiment, the energy consumption is significantly reduced because energy is required only for the actual operating switching movement, in particular the movement of the valve member from the closed position to the open position and vice versa, however, no energy is required for holding the valve in the corresponding position. This holding is on the one hand achieved by the permanent magnet within the pilot valve and holding the main valve on the other hand is achieved due to the corresponding operating position of the pilot valve for the main valve through the forces resulting from the pressure of the fluid to be controlled. The bistabile or bipolar design configuration by using at least two single coils simplifies the position detection of the pilot valve and thus of the main valve and increases the operational safety of the entire divert-air valve.

Thus, it is easily possible to spot false positions of the pilot valve and thus of the main valve and thereby taking appropriate measures to transfer the divert-air valve into a fail-safe-position. Thereby, the analysis may be performed in that a parameter of the entire coil element is detected in order to perform a position detection, however, it is alternatively possible that merely one parameter of one or all single coils is detected.

In particular the inductivity, an ohmic resistance, an impedance or any other generally simply detectable parameter of electromagnetic coils can be taken into consideration as recorded parameters. Electronics in form of an open loop and/or closed loop control device (connected to a sensing device or comprising the sensing device) may be necessary as the only additional element for position control. By a simple comparison between the target value and an actual value detected by the sensing unit it is possible to detect the position of the valve member and to transfer the pilot valve into the desired position by corresponding control signals to the coil element or single coils.

Thereby, a movement of the pilot valve is performed particularly between a closed position and an open position in which it is possible to change the pressure in a control space of the main valve so as to open or close a valve member of the main valve.

### BRIEF DESCRIPTION OF THE DRAWINGS

Further features and advantages of the embodiments are presented in the subsequent description in which preferred embodiments of the invention are described with the aid of examples shown in the following Figures.

FIG. 1 is a partial cross-sectional view of a divert-air valve in accordance with an electromagnetic valve employed as pilot valve;

FIGS. 2a and 2b are respective cross sectional views of the divert-air valve of FIG. 1 in different operating positions;

FIG. 3 is a cross sectional view of a further embodiment of an electromagnetic valve that can be used in the divert-air valve of FIG. 1;

FIG. 4 is a partial cross sectional view of a further embodiment of a divert-air valve with an electromagnetic valve employed as pilot valve; and

FIG. 5 is an enlarged view of the section A of FIG. 4.

### DETAILED DESCRIPTION

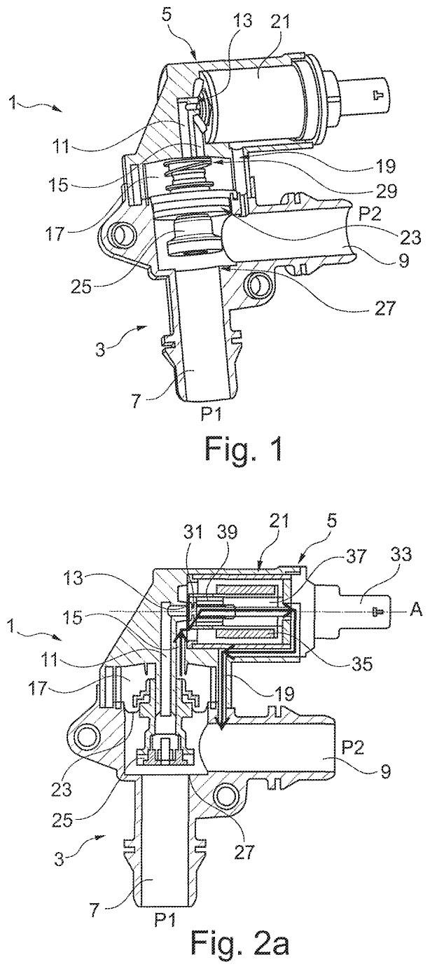

In FIG. 1, a partial sectional view of a divert-air valve 1 according to one embodiment is shown. The divert-air valve 1 comprises a main valve 3 as well as an electromagnetic control valve or pilot valve 5 realised as a 3-way-valve. The main valve 1 comprises a fluid entry 7 as well as a fluid exit 9 for a fluid to be operatively switched through the divert-air valve 1. At the fluid exit, the fluid acts with a pressure P1 while the fluid has a pressure P2 in the area of the fluid exit 9.

The pressure P1 acting at the fluid entry 7 is supplied to a valve seat 13 of the pilot valve 5 via a conduit 11 realising a valve entry of the pilot valve 5. By switching the pilot valve 5, the fluid pressure P1 prevailing in the conduit 11 may selectively be conveyed via a conduit 15 realising a valve exit of the pilot valve 5 to a control space 17 of the main valve 3, or via a line 19, which may also be called bypass-conduit, to the fluid exit 9.

As will be explained below, opening the pilot valve 5 by the actuator 21 causes the pressure P1 prevailing at the fluid entry 7 to be applied to the control space 17 as well. Due to the fact that the same pressure acts in the control space 17, that is onto the upper side of an active surface of a membrane 23 of the main valve as onto the lower side of the active surface of the membrane 23 facing the fluid entry 7, the valve member 25 of the main valve 3 is moved in the direction of the valve seat 27 of the main valve 3 and thereby a connection between the fluid entry 7 and the fluid exit 9 is closed. Due to the equality of the absolute value of the forces acting onto the respective sides of the active area of the membrane 23, closing is performed via a force acting onto the valve member 25 through the spring element 29. Thereby, relatively small forces are necessary such that the spring element 29 can be dimensioned comparatively small.

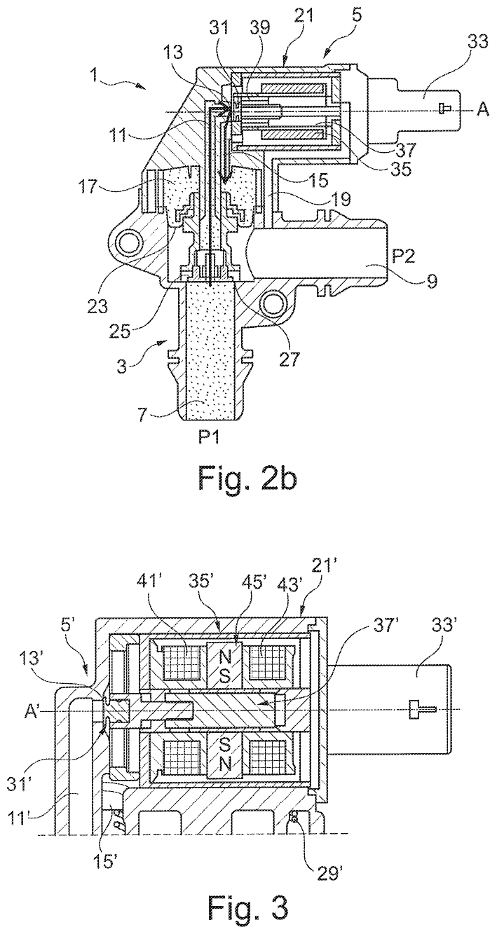

In FIGS. 2a and 2b the divert-air valve 1 is shown in the two respective operating positions. As can be discerned from FIG. 2a, the divert-air valve 1 is shown in the open position of the main valve 3. The pilot valve 5 is in a position in which a valve member 31 of the pilot valve 5 lies on a valve seat 33. This causes a connection to be established between the control space 17 and the fluid exit 9 so that the pressure P2 acts in the control space 17. This pressure P2 is, however, smaller than the pressure P1 so that the valve member 25 is lifted from the valve seat 27, thereby releasing the connection between the fluid entry 7 and the fluid exit 9. In particular, an imbalance of forces onto the active surface of the membrane 23 is present such that the pressure acting onto the lower side of the active surface of the membrane 23 is larger than the pressure acting onto the upper side in the control space 17. This difference of pressures allows the valve member 25 to be moved against the force established by the spring element 29. In case the valve member 31 or the plunger 37 is then moved by the actuator 21 along the first axis A such that it is lifted from the valve seat 13, the fluid course shown in FIG. 2b results. The pressure P1 acting at the fluid entry 7 is transferred to the control space 17 through the conduit 15 such that a pressure balance acts on the active surface of the membrane and the valve member 25 is transferred into the closed position in which the valve member 25 lies on the valve seat 27 by the spring element 29.

According to some embodiments, the actuator 21 is electrically coupled via a connection element 33 to a sensing device which is not shown. The sensing device allows for a parameter of the coil element 35 of the actuator 21 to be detected.

In FIGS. 2a and 2b, a mono-stable actuator 21 is shown. When electrically energising the coil element 35, a plunger 37 operatively coupled to the valve member 31 is moved against the force of a spring element 39 such that the pilot valve 5 is closed. When the electric energization of the coil element 35 ends, the situation shown in FIG. 2b arises, in which the plunger 37 is urged by the spring element 39 along the first axis A out of the area of the coil and thereby the valve member 13 is simultaneously lifted. Due to the different positions of the plunger 37 within the coil element 35 the inductivity of the coil element 35, is changed so that it becomes possible to detect the position of the plunger 37 and thus that of the valve member 31.

In FIG. 3, a cross sectional view of a modified embodiment of a pilot valve 5′ is shown. Such elements of the electromagnetic valve according to some embodiments in the form of the pilot valve 5′ corresponding to those of the pilot valve 5 have the same reference numerals but with a single apostrophe.

In comparison to pilot valve 5, the pilot valve 5′ has a bistabile actuator 21′. Additionally, the coil element 35′ comprises the first single coil 41′, a second single coil 43′, as well as a permanent magnet 45′. The single coils 41′, 43′ as well as the permanent magnet 45′ are formed coaxially with respect to the first axis A′ of the plunger 37′ as a ring-permanent-magnet.

This design provides the advantage that energy must only be spent for the movement of the plunger 37′ and thus of the valve member 31′. In the corresponding end position, for example the closed position of the pilot valve 5′ shown in FIG. 3 in which the valve member 31′ lies on the valve seat 13′, the necessary holding force is provided by the permanent magnet 45′.

By detecting the parameter of the single coil 41′, 43′, the position of the plunger 37′ and thus of the valve member 31′ is reliably detectable by the sensing unit. This is performed by the open loop and/or closed loop control device which is not shown, which on the one hand delivers corresponding control signals to the coil elements 35′ or the single coils 41′ and 43′ via the connection 33′ and simultaneously allows for the collection of the parameters of the single coils 41′ and 43′, in particular the inductivity thereof, and thus allows for a precise position control or position detection.

For switching the pilot valve 5′, i.e. for a switching operation, merely an impulse energization of the respective single coils 41′, 43′ or coil element 35 for approximately 200 milliseconds is necessary.

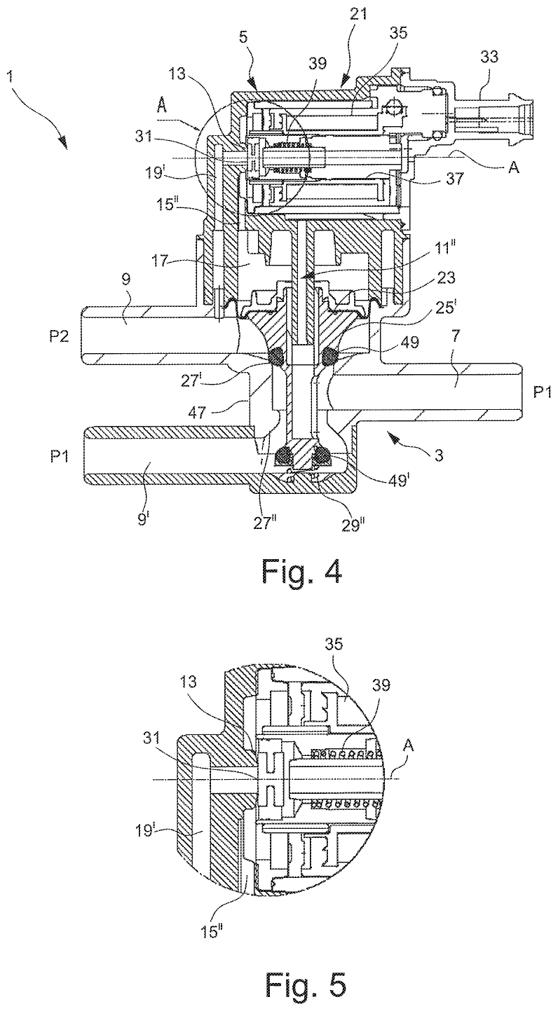

In FIG. 5, a partial cross sectional view of a divert-air valve 1 according to the invention is shown. The divert-air valve 1 comprises a main valve 3 formed as a three-way-valve as well as an electromagnetic control- or pilot-valve 5 formed as a three-way-valve. In this case, the main valve 3 and the pilot valve 5 are both three/two-way-valves. The pilot valve 5 is essentially identical to the pilot valve 5 of FIGS. 1, 2a and 2b. The pilot valve 5 may however also be formed as the pilot valve 5′ of FIG. 3. Similar or identical elements of the previously and subsequently described elements are designated with the same or similar reference numerals. The main valve 3 shown in FIG. 4 comprises a fluid entry 7 as well as two fluid exits 9, 9′. In a divert-air valve 1 according to the invention with a three-way-valve as the main valve 3 to form the fluid entry 7 and the fluid exits 9, 9′ in parallel to one another, in particular, such as shown here, in the shape of a tuning fork. The fluid exits 9, 9′ are connected via a valve member housing 47 to the fluid entry 7. Within the valve member housing 47, the valve member 25′ of the main valve 3 can be brought into two operative positions, wherein in one operative position the fluid entry 7 is connected to the fluid exit 9′, and in the other operative position the fluid entry 7 is connected to the fluid exit 9. To this end, the valve member 25′ comprises two sealing means 49, 49′, which, dependent on the operative position, seal one of the fluid exits 9, 9′ at one of the two valve seats 27′, 27″ of the valve member housing 47 against the fluid entry 9.

In FIG. 4 the operative position is shown in which the fluid entry 7 is connected to one fluid exit 9′ and in which the other fluid exit 9 is sealingly closed in relation to the fluid entry 7 by the sealing means 49 sitting on the valve seat 27′. This state of operation is achieved by setting the pilot valve 5 into a position in which the valve member 31 of the pilot valve lies on the valve seat 33 of the pilot valve. In this position of the pilot valve 5, the pressure P1 at the fluid entry 7 acts on the one fluid exit 9′ and in the control space 17. Thereby, the control space 17 is supplied with the pressure P1 via a conduit 11″ realising the valve entry of the pilot valve 5 and a conduit 15″ realising a valve exit of the pilot valve 5. The third conduit 19′ of the pilot valve 5 acts as a bypass conduit which, in the position illustrated in FIG. 4, is sealed by the valve member 31′ of the pilot valve 5 sitting on the valve seat 13′ against the control space 17. By the larger effective area of the pressure P1 on the side of the control space 17, the valve member 25′ is urged into the shown position in which the seal 49 engages the valve seat 27′ of the main valve 3.

By operating the pilot valve 5, the valve member 31 of the pilot valve can be moved away from the valve seat 13 of the pilot valve such that a connection between the fluid exit 9 and the control space 17′ is created through the conduits 19′ and 15″, through which the pressure P1 can be relieved. After the pressure-relief, the lower pressure P2 of the other fluid exit 9 acts in the control space 17. In this state, the biasing force onto the valve 25′ due to the spring element 29″ and the pressure P1 predominates against the opposing force acting through the other pressure P2 in the controller 17. Due to this, the valve member 25′ of the main valve 3 is moved into the position which is not shown, in which the fluid entry 7 is connected to the further fluid exit 9 and in which the first fluid exit 9′ is sealed off from the fluid entry 7.

Accordingly, some embodiments of a valve can be employed both for main valves in the form of two-way-valves as well as in form of three-way-valves in an advantageous manner.

This bistabile embodiment is positive for the energy efficiency in so far as an energy requirement as low as 40 wattseconds is necessary for example for a cycle duration of 10 minutes in which the pilot valve is closed for 5 minutes and open for 5 minutes for 6 cycles and a supply current of 12 volt. In comparison to this, for the actuator 21 in FIGS. 1 to 2b, an energy requirement of 13000 wattseconds is necessary which, however, is still less than the requirement for a direct electromagnetic actuation of the main valve 3 by an electromagnetic actuator having a requirement of 22000 wattseconds.

In particular the reduced energy consumption allows for the valve in accordance with some embodiments to be used in electric drive vehicles in order to switch corresponding fluid streams with an energy demand several powers of 10 lower in comparison to other divert-air valves.

In particular for an electromagnetic valve in accordance with the embodiments is usable as a pilot valve in a divert-air valve, lesser switching force results such that an actuator with a smaller assembly volume can be employed thus resulting in a more compact design. Furthermore, due to the configuration of the drive as bistabile or bipolar actuator, a reduction of energy consumption is achieved which results in an again significantly reduced weight. Due to the geometry of the main valve it is, however, simultaneously possible to switch high pressures with little energy, and the valve, in particular divert-air valve, can be used for different applications as neither the pressure nor the throughflow of a fluid influences the switching power. Simultaneously, due to the constant monitoring and the position of the pilot valve, an increased operational safety is achieved and it is assured that the divert-air valve can be transferred into a predetermined fail-safe-position in case functional defects occur. Altogether, a more compact design also results due to a simpler position analysis for a bipolar actuator by detecting the parameters of the coil element.

### LIST OF REFERENCE NUMERALS

1 divert-air valve
3 divert air valve
5, 5′ pilot valve
7 fluid entry
9, 9′ fluid exit
11, 11′, 11″ conduit
13,13′ valve seat
15, 15′, 15″ conduit
17 control space
19, 19′ conduit
21, 21′ actuator
23 active area of a membrane
25, 25′ valve member
27, 27′, 27″ valve seat
29, 29′, 29″ spring element
31, 31′ valve member
33, 33′ connection
35, 35′ coil element
37, 37′ plunger
39 spring element
41′ single coil
43′ single coil
45′ permanent magnet
47 valve member housing
49, 49′ sealing means
A, A′ axis

We claim:

1. An electromagnetic valve for controlling a main valve comprising:
at least one valve member in operative connection with at least one plunger moveable along a first axis; and
at least one coil element, wherein a movement of the at least one plunger or the at least one valve member is caused by an energization of the at least one coil element;
wherein the at least one coil element comprises at least one sensing element by which at least one parameter of the coil element can be detected, wherein a position of the at least one plunger or of the at least one vale member can be determined by the at least one parameter.

2. The electromagnetic valve according to claim 1, wherein the coil element at least sectionally coaxially, surrounds the first axis and the plunger.

3. The electromagnetic valve according to claim 2, wherein the coil element comprises at least two single coils, wherein the single coils are arranged behind one another along the first axis and at least one of the single coils surrounds the axis or the plunger at least sectionally coaxially.

4. The electromagnetic valve according to claim 3, wherein at least one permanent magnet is arranged between the two single coils with respect to the first axis, wherein the permanent magnet is at least sectionally formed as a ring magnet and is surrounding the first axis or the plunger at least sectionally coaxially.

5. The electromagnetic valve according to claim 4, wherein the sensing element detects at least one first parameter of a single coil or at least one second parameter of a second one of the single coils, wherein the permanent magnet is arranged between the first one of the single coils and the second one of the single coils.

6. The electromagnetic valve according to claim 1, further comprising at least one open or closed loop control device, wherein the open or closed loop control device is in operative connection with the sensing device, the coil element, or one of the single coils, wherein the plunger and the valve member are moveable into at least two different positions along the first axis by the open or closed loop control device.

7. The electromagnetic valve according to claim 6, wherein the movement of the plunger and of the valve member is performed by actuating the coil element dependent upon a target value provided to the open or closed loop control device via a target-value input.

8. The electromagnetic valve according to claim 7, wherein a comparison is made between the target-value input and an actual value of the plunger or of the vale member that is detected by the sensing device and is performable by the open or closed loop control device.

9. The electromagnetic valve according to claim 6, further comprising:
a first position of the plunger or of the valve member corresponds to a closed position, in which the valve member lies on a valve seat and sealingly closing a connection between at least one valve entry and at least one valve exit; and
a second position of the plunger or of the valve member corresponds to an open position, in which the valve member is at least sectionally lifted from the valve seat for opening a connection between the valve entry and the valve exit.

10. The electromagnetic valve according to claim 1, wherein the at least one parameter comprises at least an inductivity, at least an ohmic resistance, or at least an impedance of the coil element.

11. The electromagnetic valve according to claim 1 wherein the electromagnetic valve further comprises a pilot valve.

12. The electromagnetic valve according to claim 1 wherein the main valve comprises a pilot valve operated valve in a divert-air valve.

13. A divert-air valve system comprising:
at least one main valve; and
at least one pilot valve for controlling the main valve, wherein the pilot valve comprises an electromagnetic valve, the electromagnetic valve comprising:
at least one valve member in operative connection with at least one plunger moveable along a first axis; and
at least one coil element, wherein a movement of the at least one plunger or the at least one valve member is caused by an energization of the at least one coil element;
wherein the at least one coil element comprises at least one sensing element by which at least one parameter of the coil element can be detected, wherein a position of the at least one plunger or of the at least one vale member can be determined by the at least one parameter.

14. The divert-air valve system of claim 13, wherein the main valve comprises a pneumatic or hydraulic valve.
